(19) United States
(12) Patent Application Publication
(10) Pub. No.: US 2021/0374681 A1
(43) Pub. Date: Dec. 2, 2021

(54) SYSTEM AND METHOD FOR PROVIDING JOB RECOMMENDATIONS BASED ON USERS' LATENT SKILLS

(71) Applicant: PeopleStrong Technologies Pvt Ltd., Gurgaon (IN)

(72) Inventor: Amber Nigam, Gurgaon (IN)

(21) Appl. No.: 16/886,349

(22) Filed: May 28, 2020

(51) Int. Cl. G06Q 10/10; G06Q 10/06; G06N 3/04

(52) U.S. Cl. CPC G06Q 10/1053; G06N 3/0454; G06Q 10/063112

(57) ABSTRACT

The present disclosure discloses a system and a method to provide job recommendations to a user. The user logs in on a web portal where users' profile is created. Based on interaction of the user with different jobs over time, some of their latent skill sets that are hidden in these interactions are captured. Further, a trend in job selection of the user is captured using variants of Gated Recurrent Unit (GRU) to generate a set of job recommendations. Job search results generated using GRU are combined with search results obtained through traditional recommendation techniques and presented to the user. These techniques are based on analyses of similar jobs by the user or jobs applied by users possessing similar skills. The disclosure provides wholesome recommendations and solves problem of cold start for various users i.e. where the interaction of the user is unavailable that might result in no recommendations being provided to the user.

### TECHNICAL FIELD OF THE DISCLOSURE

The present disclosure relates to a job recommendation system and more particularly, to a job recommendation system with machine learning techniques by capturing latent skills of one or more users and a method to provide suitable job recommendations.

### BACKGROUND

Conventional job recommendation systems employ various content-based matching techniques, wherein jobs are recommended based on users' characteristics mapped to the corresponding available jobs. Such job recommendations are constructed by capturing the users' interaction with a job portal which is further utilised to suggest one or more jobs.

Currently, it is often witnessed that various job portals utilise numerous recommendation methodologies to generate a list of possible options for employment that may interest a specific user. For example, various social media applications use recommendation methodologies for capturing user behavior to suggest suitable videos according to the interests of the user. These recommendation methodologies generally provide predictions based on three kinds of user behavior: a) content-based filtering b) collaborative filtering and c) hybrid filtering. The content-based filtering methodology may examine a user's interest based on the frequency of clicks to display relevant content. Meanwhile, the collaborative filtering methodology may predict a user's interest by identifying the interests of one or more similar users. The hybrid filtering methodology may capture features of both the above-mentioned methodologies by examining actions and/or interests of the user and a group of similar users to recommend interests.

Increasingly, job recommendation systems are integrating machine learning models for capturing the users' interests by employing either content-based or collaborative filtering techniques to provide a suitable job recommendation list to the user. To this end, Massimo et al., Sequence aware recommendation system provides a recommendation system that generates new recommendations corresponding to a user by analysing his/her behavioral pattern to detect multiple trends which is subsequently fed as an input to existing machine learning algorithms that may have application in various fields such as music recommendation, advertisement recommendation etc. Similarly, Qingxin Meng et al., A Hierarchical Career-Path-Aware Neural Network for Job Mobility Prediction discusses that an initial profile of a user may be analysed by LSTM, a machine learning technique, to predict the next possible employer or job of the user. The research paper focusses on understanding potential career path of a user by analysing historical and environmental factors influencing job mobility. This model seeks to integrate three levels of information, including personal-specific, company-specific and position-specific factors. The position-specific information is used as an input to LSTM layer and is then linked with embeddings of the company-specific factors and is finally fed as an input to another LSTM layer.

Further, patent WO 2019/023358 utilises several machine learning algorithms and describes training a pair of machine learning models on the basis of queries and search results. The training data comprises of sample job postings' search results and results selected by members, along with the information about people who performed corresponding searches. Such training data is fed into machine learning algorithm to determine a similarity score between the queries and the results. Additionally, patent US 2019/0130281 discloses a system to predict next career move of a candidate by employing an encoder-decoder model that uses LSTM to understand present career trajectory of the candidate.

However, the above discussed technical literature fails to focus upon including covert skills and/or latent skills of the user to suggest one or more job recommendations which may lead to omission of certain jobs that are not exactly matching with the keywords used to describe the user's profile and/or listed skill set. Thus, it is essential to integrate the user's interests, profile, domain and career path to focus upon implicit skill set acquired by the user in a specific domain. In essence, existing methods and associated systems may provide only a partial job recommendation due to non-inclusion of latent skills while generating job recommendations, thus leading to abridged career development support to the user.

Thus, there exists a need for methods and systems that may capture a combination of both explicit skills such as including but not limited to user's skills, location, educational background, previous jobs etc. and implicit skills such as, but not limited to, one or more latent skills of a user to encompass the entire latent skill set of the user that results in providing holistic recommendations.

### SUMMARY

One or more shortcomings of prior arts are overcome, and additional advantages are provided through present disclosure. Additional features are realized through techniques of the present disclosure. Other embodiments and aspects of the disclosure are described in detail herein and are considered a part of the present disclosure.

In one aspect of the disclosure, a recommendation system to generate one or more job recommendation is disclosed wherein the recommendation system comprises a communication interface, through which users interact with the system and see their job recommendations, a feature module, comprising of user profile, candidate and job industry, location, job domain, educational requirement and skills, a job filter, in connection with a feature module capable of accessing one or more user profiles interacting with a communication interface and filtering them to provide a subset relevant jobs. Further, a recommendation composer module may extract at least one job filter to create a set of filtered jobs which are processed further to generate final recommendation A Gated Recurrent Unit (GRU) processing is performed on the set of filtered jobs, the sequence of interaction data vector and the latent competency vector to obtain a first set of job recommendations. The recommendation system may further include an analyses module that provides a comparison between the set of filtered jobs and a plurality of previously applied jobs extracted from the communication interface to obtain a second set of job recommendations along with an evaluate module that provides a comparison between the set of filtered jobs and the jobs applied by one or more similar candidates extracted from the communication interface to obtain a third set of job recommendations; wherein the communication interface may present a combined set of job recommendations including the first, the second and the third set of job recommendations basis a predefined threshold.

In another aspect of the disclosure, a method to generate one or more job recommendation is provided wherein the method includes creation of at least one job filter based on a feature module, wherein the feature module is configured to access one or more user profiles interacting with a communication interface; further wherein the feature module is constructed using a combination of a set of predefined parameters; The set of filtered jobs are subsequently enumerated by a recommendation composer module to generate final set of job recommendations; An interaction data vector that is computed by a plurality of interaction data including a user's job interests, a user's job selection, a user's job preferences, a user's job rejections, wherein the at least one set of interaction data is obtained through the communication interface; A set of latent competency vector based on the similarity between a domain vector and a user vector, wherein the domain vector is constructed using a plurality of domain skills and the user vector is constructed using a plurality of user skills, wherein the domain skills and the user skills are obtained through the feature module; A first set of job recommendations is computed using a Gated Recurrent Unit (GRU) model, wherein the GRU model is applied on the set of filtered job, the at least one set of latent competency vector, and the at least one set of interaction data vector. The second set of job recommendation is created by comparing the set of filtered jobs with one or more previously applied jobs by the user; and a third set of job recommendation is estimated by comparing the set of filtered jobs with the one or more jobs applied by the similar user profiles based on the presence of interaction data vector. A combination of set of job recommendations is presented to the user through the communication interface pushed by the recommendation composer module based on a pre-determined threshold applied to the first, the second and the third set of job recommendations.

Foregoing summary is illustrative only and is not intended to be in any way limiting. In addition to the illustrative aspects, embodiments, and features described above, further aspects, embodiments, and features will become apparent by reference to drawings and following detailed description.

### BRIEF DESCRIPTION OF DRAWINGS

FIG. 1 is a diagram representing an exemplary illustration of a job recommendation system.

FIG. 2 represents components of a feature module, according to one of exemplary embodiment of the disclosure.

FIG. 3 represents various attributes of a latent competency vector.

FIG. 4 represents an interaction data vector.

FIG. 5 diagrammatically represents linking of building blocks of a job recommendation system.

FIG. 6 represents a simplified schematic diagram illustrating an exemplary flowchart for capturing latent competencies of a user to provide job recommendations.

FIG. 7 represents machine learning models according to one of the exemplary embodiments of the disclosure where h₁, h₂ . . . hₙ represent hidden layer and a₁, a₂ . . . aₙ represent attention layer.

FIG. 8 is a T-SNE plot of final Word2Vec model with some sample skills, according to one embodiment of the present disclosure.

FIG. 9 and FIG. 10 are one or more heatmaps highlighting latent competencies for users and jobs respectively.

FIG. 11 is a superimposition of latent competency heatmaps between jobs and candidates to highlight common latent competency groups.

### DETAILED DESCRIPTION

In following detailed description of embodiments of present disclosure, numerous specific details are set forth in order to provide a thorough understanding of the embodiments of the disclosure. However, it will be obvious to one skilled in the art that the embodiments of the disclosure may be practiced without these specific details. In other instances, well known methods, procedures, components, and circuits have not been described in detail so as not to unnecessarily obscure aspects of the embodiments of the disclosure.

References in the present disclosure to “one embodiment” or “an embodiment” mean that a feature, structure, characteristic, or function described in connection with the embodiment is included in at least one embodiment of the disclosure. Appearances of phrase “in one embodiment” in various places in the present disclosure are not necessarily all referring to same embodiment.

In the present disclosure, word “exemplary” is used herein to mean “serving as an example, instance, or illustration.” Any embodiment or implementation of present subject matter described herein as “exemplary” is not necessarily to be construed as preferred or advantageous over other embodiments.

The present disclosure may take form of a hardware embodiment, a software embodiment, or an embodiment combining software and hardware aspects that may all generally be referred to herein as a ‘system’ or a ‘module’. Further, the present disclosure may take form of a computer program product embodied in a storage device having computer readable program code embodied in a medium.

While the disclosure is susceptible to various modifications and alternative forms, specific embodiment thereof has been shown by way of example in drawings and will be described in detail below. It should be understood, however that it is not intended to limit the disclosure to the forms disclosed, but on contrary, the disclosure is to cover all modifications, equivalents, and alternative falling within scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude existence of other elements or additional elements in the system or apparatus.

In the following detailed description of the embodiments of the disclosure, reference is made to the drawings that form a part hereof, and in which are shown by way of illustration specific embodiments in which the disclosure may be practiced. These embodiments are described in enough detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure describes a method to analyse psychometric variables, past career history, user skills, education background to capture parameters such as aspiration of a user, trend of job selection, progression of job selection by a user to provide a set of serendipitous job recommendations. In an exemplary embodiment, the present disclosure relates to a job recommendation system that may employ a machine learning model and/or in combination with one or more recommendation techniques to predict one or more jobs to a user. The machine learning model may be based on a sequential analysis of time-dependent log of past user activity that may capture nuances in type of job selection by the user in order to predict future user actions, whereas traditional job recommendation techniques analyse similarity of a job with the other type of job selections done by the user and with type of job selections done by users possessing similar skills. End-recommendations are presented to the user by combining results obtained from these two techniques.

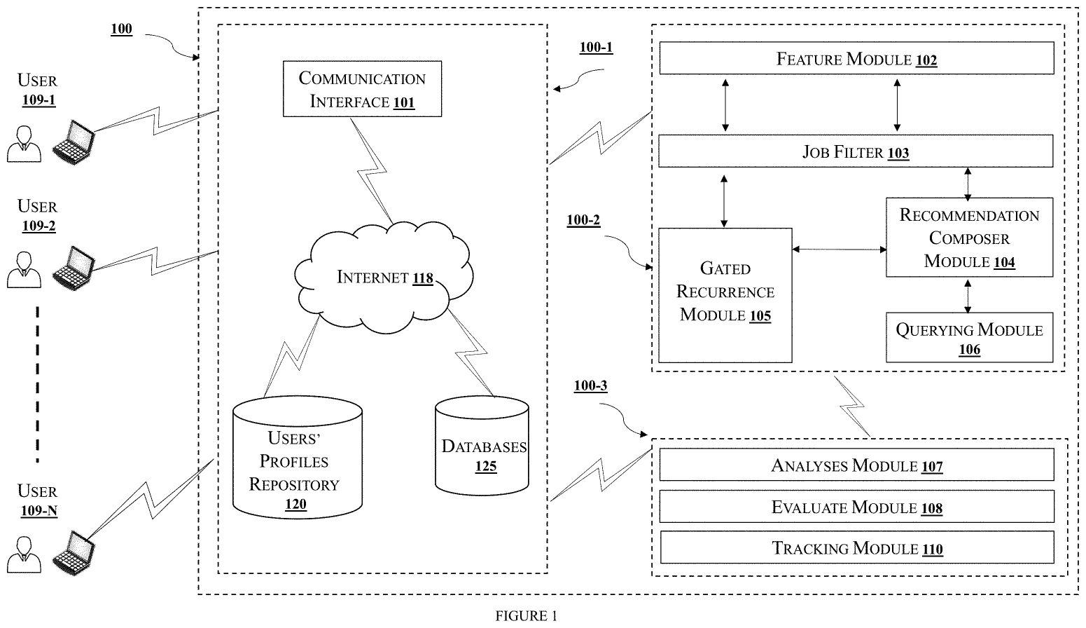

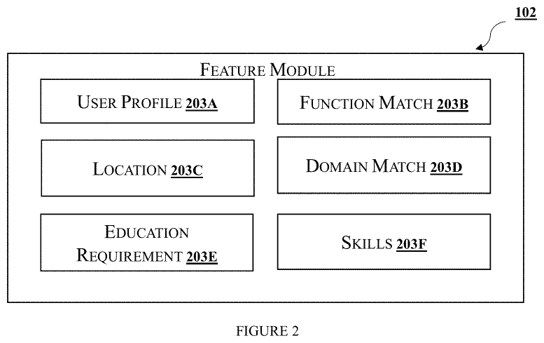

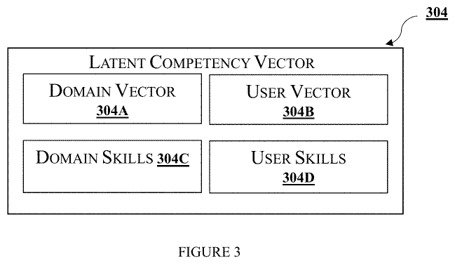

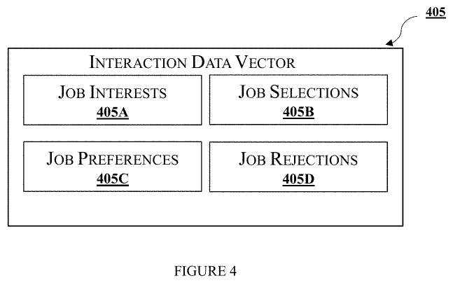

Referring to FIG. 1, a job recommendation system 100 is disclosed wherein a plurality of users (109-1, 109-2 . . . 109-n) interact with a job portal wherein the users' profile repository 120 is forwarded to a recommendation composer module 104. The recommendation composer module 104 may extract one or more features of the users' (109-1, 109-2 . . . 109-n) through a feature module 102 that comprises of a plurality of user-related features as disclosed in FIG. 2 such as user profile 203A, function match 203B, location 203C, domain match 203D, educational requirement 203E and skills 203F in order to build a job filter 103 to extract a subset of relevant jobs from one or more database (s) 125 including universe of job openings that might match with the user's (109-1 . . . 109-N) skills. Further, in FIG. 3, a domain vector 304A, a user vector 304B are generated from domain skills 304C and user skills 304D respectively to form a latent competency vector 304 to capture the latent or covert or implicit skills of the user (109-1 . . . 109-N). The user (109-1 . . . 109-N) when interacts with the job portal through a communication interface 101, the interactions of the user (109-1 . . . 109-N) may get captured and converted into an interaction data vector 405 in FIG. 4 that includes, but not limited to, of a user's job interests 405A, job selection 405B, job preferences 405C and job rejections 405C amongst other user choices to capture the user behavior.

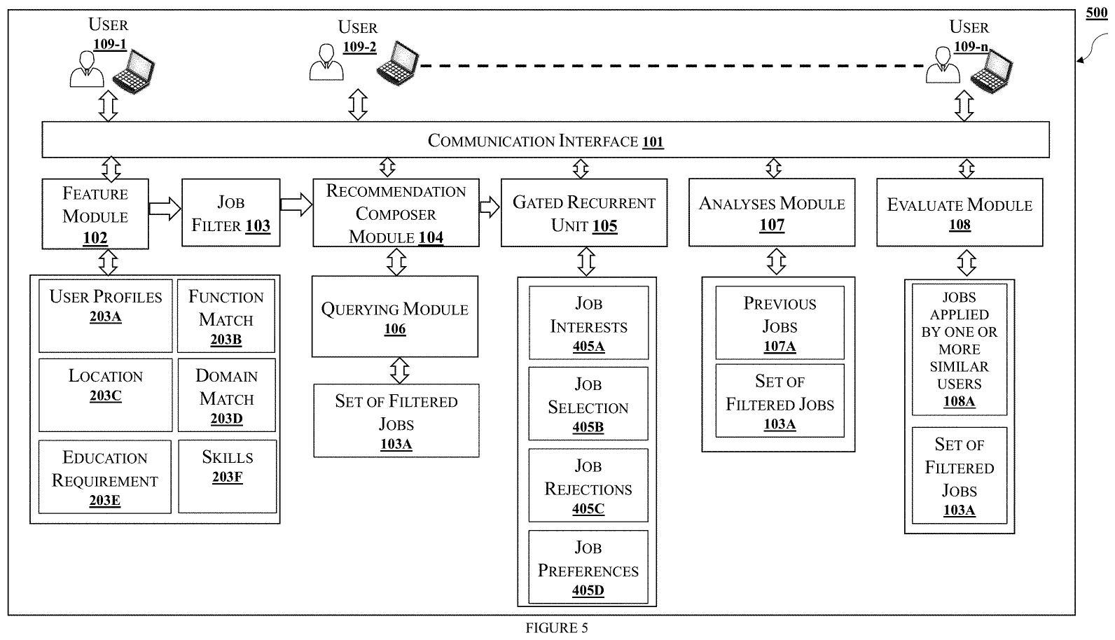

The recommendation composer module 104 then subsequently forwards the job filter 103 to a querying module 106. The role of the querying module 106 is to construct queries according to the job filters 103 provided to it, to fetch the relevant jobs from the databases 125 and present output in both raw and vectorized formats. The vectorized format can be directly used as an input to the machine learning models or for other vectorized computations whereas the raw format can be used to compose human readable recommendations. The querying module 106 then presents the recommendation composer module 104 with the set of filtered jobs 103A as shown in FIG. 5.

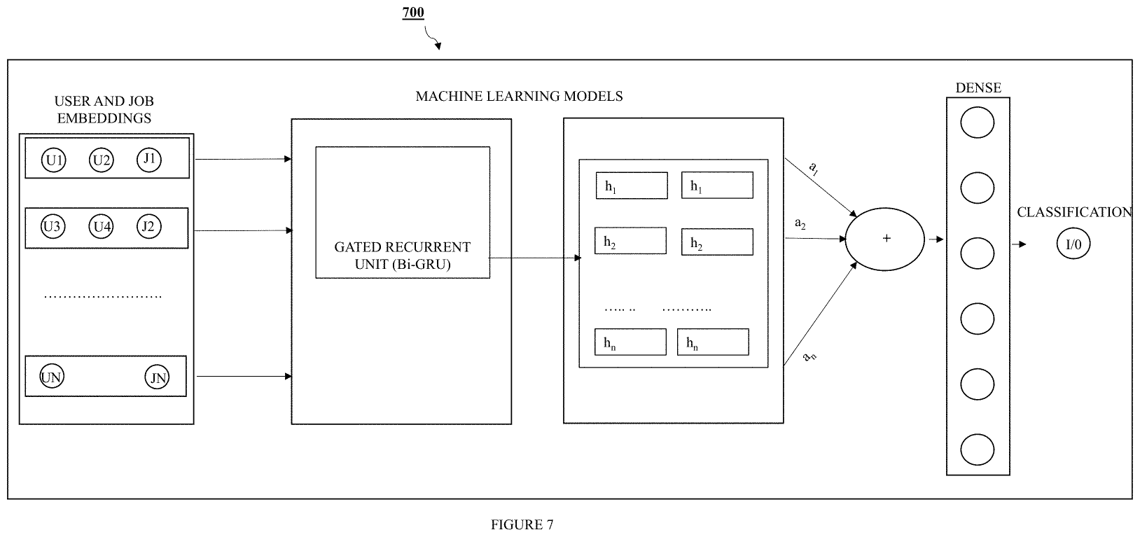

As illustrated in FIG. 7, a machine learning technique GRU (Gated Recurrent Unit) 105 is then applied on the sequence of interaction data vector 405 as shown in FIG. 4, comprising of the latent competency vector 304 and other feature vector available through feature module 102 as shown in FIG. 2, to generate a first set of job recommendations for the user (109-1 . . . 109-N). The GRU 105 model may further include an attention model. The communication interface 101 may be linked to the users' profiles repository 120 and a database 125 through internet connection 118. The repository and the database may provide relevant jobs to the communication interface 101.

In an embodiment, the system 100 may include a central processing unit (“CPU” or “processor”). The processor may comprise at least one data processor for executing program components for executing user or system-generated business processes. The processor 502 may include specialized processing units such as integrated system (bus) controllers, memory management control units, floating point units, graphics processing units, digital signal processing units, etc.

The processor may be disposed in communication with one or more input/output (I/O) devices via communication interface 101. The communication interface 101 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the communication interface 101, the system 100 may communicate with one or more I/O devices. In some implementations, the processor may be disposed in communication with a communication network via a network interface. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network can be implemented as one of the several types of networks, such as intranet or any such wireless network interfaces. The communication network may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network may include a variety of network devices, including routers, bridges, servers, computing devices, storage devices, etc.

In some embodiments, the processor may be disposed in communication with a memory e.g., RAM and ROM via a storage interface. The storage interface may connect to memory including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory may store a collection of program or database components, including, without limitation, user/application, an operating system, a web browser, a mail client, a mail server, a user interface, and the like. In some embodiments, the system 100 may store user/application data such as the data, variables, records, etc. as described in this disclosure. Such databases may be implemented as fault-tolerant, relational, scalable, secure databases such as Oracle or Sybase.

The operating system may facilitate resource management and operation of the system 100. Examples of operating systems include, without limitation, Apple Macintosh™ OS X™, UNIX™, Unix-like system distributions (e.g., Berkeley Software Distribution (BSD), FreeBSD™, Net BSD™, Open BSD™, etc.), Linux distributions (e.g., Red Hat™, Ubuntu™, K-Ubuntu™, etc.), International Business Machines (IBM™) OS/2™, Microsoft Windows™ (XP™, Vista/7/8, etc.), Apple iOS™, Google Android™, Blackberry™ Operating System (OS), or the like. The communication interface 101 may facilitate display, execution, interaction, manipulation, or operation of program components through textual or graphical facilities. For example, user interfaces may provide computer interaction interface elements on a display system operatively connected to the system 100, such as cursors, icons, check boxes, menus, windows, widgets, etc. Graphical User Interfaces (GUIs) may be employed, including, without limitation, Apple™ Macintosh™ operating systems' Aqua™, IBM™ OS/2™, Microsoft™ Windows™ (e.g., Aero, Metro, etc.), Unix X-Windows™, web interface libraries (e.g., ActiveX, Java, JavaScript, AJAX, HTML, Adobe Flash, etc.), or the like.

As described above, the modules, amongst other things, include routines, programs, objects, components, and data structures, which perform particular tasks or implement particular abstract data types. The modules may also be implemented as, signal processor(s), state machine(s), logic circuitries, and/or any other device or component that manipulate signals based on operational instructions. Further, the modules can be implemented by one or more hardware components, by computer-readable instructions executed by a processing unit, or by a combination thereof.

The recommendation composer module 104 may display a final list of recommendations to the user (109-1 . . . 109-N) through a communication interface 101. The combined or final set of job recommendations may be presented to the user (109-1 . . . 109-N) by blending a set of recommendations from a machine learning module with two or more sets obtained from the non-machine learning modules.

In another embodiment, referring to FIG. 5 which may disclose an analyses module 107 and an evaluate module 108 that may capture preferences of the user (109-1 . . . 109-N) through non-machine learning techniques. The analyses module performs analysis on previous jobs 107A applied by the users (109-1 . . . 109-N) derived from a set of filtered jobs 103A. Further, the evaluate module 108 may performs analysis on the one or more jobs applied by similar users 108A ultimately derived from the set of filtered jobs 103A. A tracking module 110 may further analyse the final recommendations, obtained from all modules to make sure that a job recommendation appears in the final set of job recommendations for a minimum ten times number of openings for the recommendation.

In another embodiment, the job filter 103 as shown in FIG. 1 and FIG. 5 may be created using the feature module 102 by using a combination of one or more parameters such as, but not limited to:

a) matching of 20 percent skills match between jobs and user (109-1 . . . 109-N)
b) function 203B and/or domain match 203D i.e. an engineering graduate user would be shown jobs in engineering domain
c) job filter 103 that removes jobs (for very experienced users, say 20 years) from job recommendations for freshers, and vice-versa.
d) job role's education requirement
e) job role's previous minimum experience requirement
f) location 203C proximity between job and user (109-1 . . . 109-N)

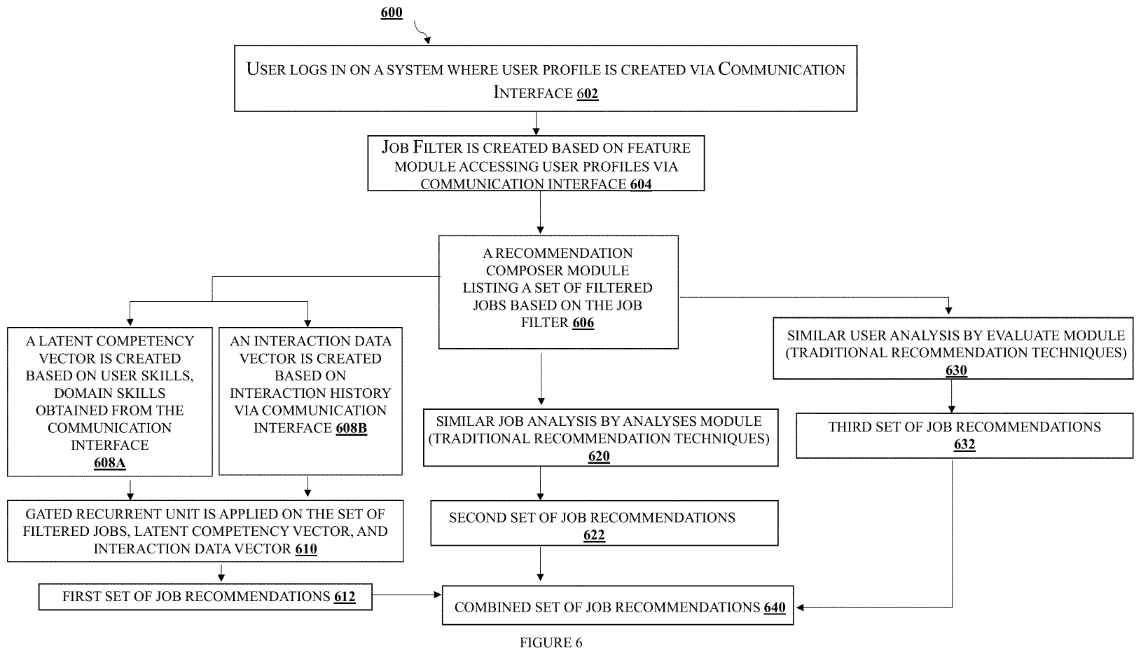

Referring to FIG. 6, the method of generating job recommendations is disclosed, at step 602, a user (109-1 . . . 109-N) logs in onto the system 100 using the job portal through the communication interface 101. A job filter 103 may be created basis the feature module 102, wherein the feature module 102 is capable of accessing the user profiles 203A via the communication interface 101 at step 604. The obtained job filter 103 is submitted by the recommendation composer module 104 to the querying module 106 that may respond with the set of filtered jobs 103A, J_{filtered}.

Further, at step 606, the recommendation composer module 104 may list the set of filtered jobs (J_{filtered}) 103A, based on the job filter 103. The set of filtered jobs (J_{filtered}) 103A forms the basis for three types of recommendations. In next steps 608A and 608B, the interactions of the user (109-1 . . . 109-N) are analysed. Using J_{filtered} 103a and the interactions, the user vector 304B and job features may be used to predict suitable jobs using the GRU 105 by sorting the shortlisted jobs on decreasing order to generate an initial list of ranked set of first set of job recommendation.

The Step 608A describes the generation of latent competency vector 304 and step 608B suggests creation of the interaction data vector 405. Basis both the vectors at step 610, it is suggested that the GRU 105 may provide the first set of job recommendations at step 612. At step 620 and 622, the analysis by the analyses module 107 based on the previous jobs applied by the user 107A is performed to further provide the second set of job recommendations. Using the J_{filtered} 103A, a set of jobs previously applied by the user 107A are found and similar jobs where cosine similarity score with other jobs is >=0.70 are shortlisted. The shortlisted jobs are then sorted on decreasing order to generate a second set of job recommendation. The step 608A assists in solving a cold start problem due to picking up a new job similar to the job to which is it compared.

At step 630 and 632, the third set of job recommendations is generated by the evaluate module 108 based on the jobs applied by similar users 108A. Using the user vector 304B, similar users are selected where cosine similarity score with other users is >=0.80. From the set of filtered jobs J_{filtered} 103A, jobs applied by similar users 108A are fetched, sorted in decreasing order of their created-on attribute and a third set of job recommendation list is prepared. This step may aid in solving user cold-start problem since the interactions of the user is not required.

In embodiments, if the first set of job recommendations is non-empty, one or more jobs may be added in first set of job recommendations to the final or combined set of job recommendations. Next, two jobs may be added in final or combined set of job recommendations from the second set of job recommendations and the third set of job recommendations respectively and may be inserted at random positions in the first set of job recommendations for every 10 jobs. If the first set of job recommendations is empty, jobs from the second set of job recommendations and the third set of job recommendations may be alternately added to the final or combined set of job recommendations. In order to account for an edge case where the final or combined set of recommendation, is empty, the final or combined set of job recommendations may be prepared using overlap between the user (109-1 . . . 109-N) and jobs using the J_{filtered}. In case the final or combined set of job recommendations includes first set of job recommendations, then the second set of job recommendations and the third set of job recommendations together may not constitute more than 20 percent in the final or combined set of job recommendations.

Finally, at step 640 the combined set of job recommendations are presented to the user (109-1 . . . 109-N) through the communication interface 101.

In an embodiment, the interactions of the user (109-1 . . . 109-N) with the system 100 may provide a constant source of data for the present system 100. The interactions may be captured by one or more of following methods; a) recruiter tagging a user (109-1 . . . 109-N) for the job, b) a user (109-1 . . . 109-N) clicking on the job to further expand its contents and c) the user (109-1 . . . 109-N) clicking apply button to start their job application process. These are all favorable or positive outcomes and correspond to a user's (109-1 . . . 109-N) positive interaction with a job. A separate subset of jobs that have been ignored by the user (109-1 . . . 109-N) form negative outcomes. This data is fed into machine learning algorithms where an algorithm tries to predict a positive (1) outcome or a negative (0) outcome generated by the user (109-1 . . . 109-N) for any given job. Example of several types of user interactions are summarized in Table 1.

### Example 1

TABLE 1
Dataset of user interactions

| Positive interactions | |
|---|---|
| Recruiter tagged a user to a job | 215218 |
| User expanded a job | 72794 |
| User applied to a job | 28486 |
| Total | 316498 |
| Negative interactions | |
| User ignored job shown | 809278 |

At least 10 features from each user (109-1 . . . 109-N) and 11 features from each job and one common feature are combined. A total of at least 22 features are used that are described by a set of categorical, numerical or descriptor features are used. Table 2 demonstrates examples of aggregation various features to generate vectors.

### Example 2

TABLE 2
User-job features used to generate vectors

| Feature type | Feature |
|---|---|
| Categorical | Tech/Non-tech, City, Organization |
| Numerical | Experience, Age, Seniority, Freshness, |
| | Latent Competency Group Similarity |
| Descriptor | Function Name, Industry Name, Education, |
| | Skills |

Examples of dimensionality of each feature is given in Table 3. Descriptor features have a vocabulary size of 4000-5000 and categorical features take up to 128 values. Examples of categorization of the features into high, medium and low are shown in Table 4, and Table 5 summarizes the probable weightage of each feature.

### Example 3

TABLE 3
Dimensions of each feature

| Features | Dimensions |
|---|---|
| Tech/Non-tech (c) | 1 |
| City ID: (c) | 8 |
| Organization ID: (c) | 4 |
| Function name: (c) | 4 |
| Industry name: (c) | 4 |
| Education: (c) | 8 |
| Skills: (c) | 20 |
| Experience: (c) | 1 |
| Age (c) | 1 |
| Seniority (c) | 1 |
| Tech/Non-tech (j) | 1 |
| City ID: (j) | 8 |
| Organization ID (j) | 6 |
| Function Name (j) | 6 |
| Industry Name (j) | 5 |
| Education (j) | 8 |
| Skills (j) | 20 |
| Freshness level (j) | 1 |
| Seniority (j) | 1 |
| Minimum Experience (j) | 1 |
| Maximum Experience (j) | 1 |
| Latent Competency Group Similarity (c-j) | 1 |
| Total | 111 |

TABLE 4
Dimensions of user features

| User Features | Importance |
|---|---|
| Age | Medium |
| Education | Medium |
| City ID | Low |
| Skills | High |
| Experience | Medium |
| Function name | Medium |
| Industry name | Medium |
| Seniority | Low |
| Organization ID | High |
| Tech/Non-tech | Low |

TABLE 5
Probable weightage of each feature

| | Importance |
|---|---|
| Job Features | |
| Freshness level | Medium |
| Education | Low |
| City ID | Medium |
| Skills | High |
| Function name | Medium |
| Industry name | High |
| Seniority | Low |
| Maximum experience | Medium |
| Minimum experience | Medium |
| Organization ID | Medium |
| Tech/non-tech | Low |
| User-job features | |
| Latent competency group similarity | High |

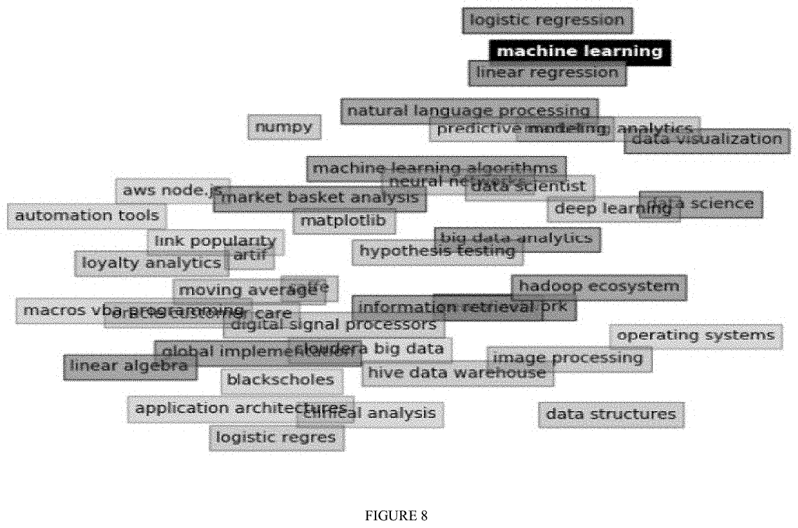

As shown in FIG. 8 in order to represent the user (109-1 . . . 109-N) and the skills in a dataset, word embeddings learned by Word2Vec model is used. Dimensionality of word vectors is 20, training algorithm is continuous Bag-of-Words, window size is 5 and min count is 5.

In an embodiment, Latent Competency Group (LCG) similarity is used to predict the covert and cognitive skills of the user (109-1 . . . 109-N). The latent competency group similarity contributes around 40 percent to total overall skill sets of the user (109-1 . . . 109-N). The LCG similarity would enable the system to capture the skills that are not otherwise expressly mentioned in resume of the user yet are possessed by the user by virtue of their profile. For instance, a user (109-1 . . . 109-N) who mentions Full Stack Developer as a skill might have latent competencies in Microservices, Web Development, JavaScript, Angular, etc. Similarly, a recruiter posting a job having skill requirements of a Web Developer may also be interested in users having competencies in HTML, Microservices, JavaScript and so on. The Latent Competency Group Similarity between the job and the user (109-1 . . . 109-N) along with skills would assist the machine learning models to make better inferences.

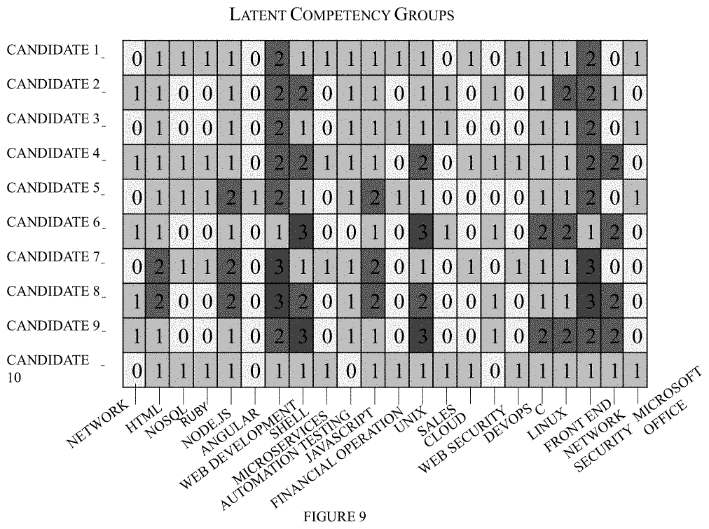

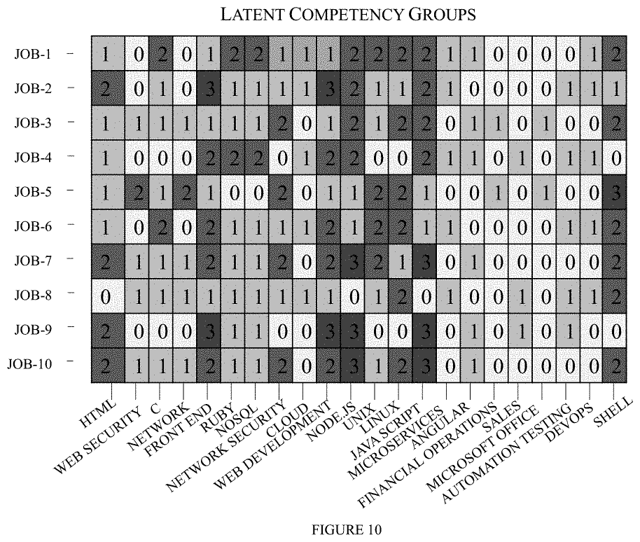

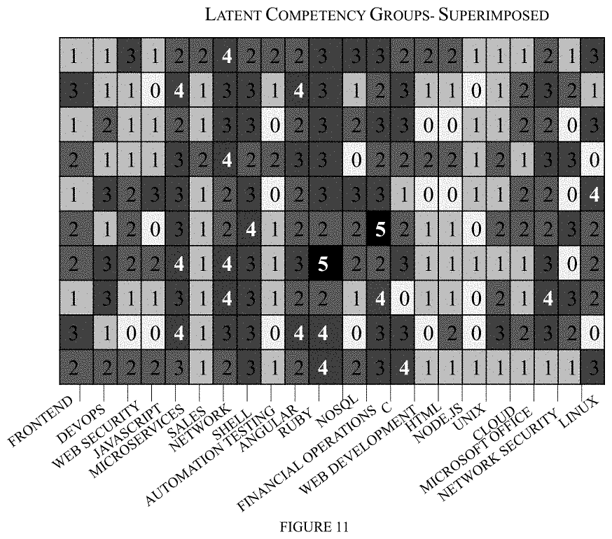

FIGS. 9, 10 and 11 may visually demonstrate the commonality of skills between candidates and jobs using heatmaps. Herein the candidates and users may be used interchangeably. FIG. 9 includes a row represents a candidate, i and column represent a Latent Competency Group, j. Each skill of the candidate is mapped to its corresponding Latent Competency and the position (i, j) is incremented by 1 if the skill lies in the corresponding Latent Competency Group. FIG. 10 is constructed similarly using jobs, such that candidates applied to jobs. FIG. 11 is constructed by adding the values (i, j) from FIGS. 9 and 10 respectively thereby representing the number of times the Latent Competency Group of candidates matched with that of jobs.

Latent Competency Groups are domain specific aggregation of skills. For example, skills such as linear regression, natural language processing, deep learning, data visualization and so on belong to one machine learning competency group. The Latent Competency Groups attempt to analyse overlap of domains between the jobs and the users. When the user (109-1 . . . 109-N) interacts with the web or job portal over time, some of their latent preferences are hidden in these interactions. The datasets are modelled to capture these changing job-preferences of the user over time, along with explicit changes in the user's features over time, such as skills and location.

The user skills or job requirements are represented by a vector where each dimension represents a latent competency group. For each user (109-1 . . . 109-N) or job, first a vector V of size 100 is created and initialized with 0's. Each index in this vector represents a group. For each skill, associated groups are identified, and 1 is added to the corresponding indices in V. Second, values in V are normalized between 0 and 1. Next, the latent competency group similarity is computed which is cosine similarity value of V_{c} and Vⱼ, where V_{c} represents user latent competency group vector and Vj represents job latent competency group vector.

Expansion of the skills into the latent competency groups using above methodology attempts to capture the latent or covert or implicit skills that humans can infer but may remain hidden for machine learning models due to the brevity used by recruiters and the users or candidates while mentioning the skills.

Table 6 summarizes various machine learning models used to predict user preferences

TABLE 6
Different machine learning models used to predict user preferences

| Machine learning models | Hyper-parameters |
|---|---|
| Random Forest | Criterion: gini |
| | N_estimators: 300 |
| XGBoost | N_estimators: 500 |
| Bi-GRU | Timesteps:2 |
| | Hidden Layers: 2 (Nodes: 128, 64) |
| | Optimizer: Adam |
| | Dropout:20% |

Several machine learning algorithms that included both tree-based approaches and deep neural networks are used to generate a set of recommendations. Random Forests and XGBoost that are tree-based approaches that can be used to generate the recommendations. However Bi-GRU provides superior results due to its ability to learn progression in the form of sequences and use interaction information from the past to predict future outcomes. The attention mechanism helps to mimic the visual attention mechanism of humans loosely.

When a candidate interacts with different jobs over time, some of their latent preferences are hidden in these interactions. The training data is modeled to capture these changing job-preferences of candidates over time, not to mention any explicit changes in candidate's attributes over time, like skills and location, are also captured (see Equation 1). In Equation 1, during training the Bi-GRU, CJ₁ (first timestep) is a candidate job pair where candidate C positively interacts with job J₁. C′J₂ (second timestep) represents the same candidate (with updated attributes) at a later point in time and job J₂. The target variable is 1 or 0, depending on whether C′ positively or negatively interacts with J₂ respectively.

CJ₁ [symbol] C′J₂ [symbol] 1/0

During testing, while predicting whether a candidate will positively interact with a job, attributes of the last job applied to by the candidate (J₁) and the attributes of the candidate's profile (C), at the time C positively interacted with J₁, forms the first timestep. The job in question (J₂) and the candidate's current profile (C′) are used to form the second timestep. The model predicts if C′ will positively or negatively interact with J₂.

To provide wholesome end recommendations, the system and method may use a blended approach where non-machine learning based techniques may be employed. Combination of the machine learning and the non-machine learning techniques provided significant improvement in overall job recommendations as the blended approach and saw a relative increase of 63% in click-through rates (CTR). Results are statistically significant by chi-square test at p<0.01.

The machine learning model is based on a Gated Recurrent Unit (GRU) 105, wherein at predefined time stamps, latent skills and/or preferences hidden in user interactions are captured from provided input in the form of sequential data. The latent preferences are then used to predict probability of next items in the sequence. A recurrent feedback mechanism memorizes effect of past data in order to determine next possible job position of the user to provide serendipitous end-recommendations. The GRU 105 and its variants are capable of modelling longer and complex temporal dependencies to capture such dynamically changing real-time job-preferences of the users along with explicit changes in user's characteristics over a certain period. Expansion of the skills into latent competency groups using above methodology attempts to capture latent skills that humans can infer but may remain hidden from machine learning models due to brevity used by recruiters and candidates while mentioning the skills.

We claim:

1. A recommendation system to generate one or more job recommendation for candidates where the system comprising of:
a communication interface, enabling a plurality of candidates to interact with the system and displaying job recommendations;
a feature module, a job filter, leveraging the feature module to filter relevant jobs from a database;
a Gated Recurrent Unit (GRU) processing on a set of filtered jobs, a sequence of interaction data vector and a latent competency vector to obtain a first set of job recommendations; an analyses module using similarity between the set of filtered jobs and previously applied jobs extracted from the communication interface to obtain a second set of job recommendations;
an evaluate module using similarity between the set of filtered jobs and the jobs applied by one or more similar candidates extracted from the communication interface to obtain a third set of job recommendations; and
a recommendation composer module, extracting the set of filtered jobs using the job filter and combining the job recommendations coming from the GRU processing, the analyses module and the evaluate module basis a predefined threshold to form a combined set of job recommendations.

2. The system as claimed in claim 1, wherein the feature module is generated based on a plurality of parameters extracted from one or more user profiles including but not limited to function match, domain match, educational requirements, location proximity between users and jobs, and matching of skills between the users and the jobs.

3. The system as claimed in claim 1, wherein the recommendation composer module lists one or more jobs basis the at least one job filter; wherein the job filter is determined by the feature module.

4. The system as claimed in claim 1, wherein the interaction data vector comprises of a user's job interests, a user's job selection, a user's job preferences, a user's job rejections, wherein the at least one set of interaction data is obtained through the communication interface.

5. The system as claimed in claim 1, wherein the Gated Recurrent Unit (GRU) is modulated to analyze past sequential interaction data of one or more user profiles to predict the at least one set of job recommendations.

6. The system as claimed in claim 1, wherein the analyses module includes performing a cosine similarity analysis for the set of filtered jobs and the one or more previously applied jobs by a user to generate a second set of job recommendations.

7. The system as claimed in claim 1, wherein the evaluate module includes performing a cosine similarity analysis with the one or more user vectors to generate a cosine similarity score to identify set of jobs applied by similar users to determine the third set of recommendations.

8. The system as claimed in claim 1, wherein the communication interface presents the combined set of job recommendations wherein contribution by the analyses module and the evaluate module is less than or equal to 20 percent of total jobs recommendations when the combined set of job recommendations include recommendations from the first set of job recommendations.

9. A system in communication with the recommendation system including a tracking module to track the combined set of job recommendations wherein the tracking module tracks for total recommendations wherein the total recommendations are at least ten times of total number of openings.

10. A method to generate one or more job recommendation, the method comprising:
creating a filtered set of jobs relevant for a user through a job filter module wherein the jobs filters are created based on a feature module, wherein the feature module is constructed using a combination of a set of predefined parameters for jobs and user profiles interacting with a communication interface;
determining interaction data vector computed by a plurality of interaction data including a user's job interests, a user's job selection, a user's job preferences, a user's job rejections, wherein the at least one set of interaction data is obtained through the communication interface;
determining latent competency vector based on the similarity between a domain vector and a user vector, wherein the domain vector is constructed using a plurality of domain skills and the user vector is constructed using a plurality of user skills, wherein the domain skills and the user skills are obtained through the feature module;
computing a first set of job recommendation by using a Gated Recurrent Unit (GRU) model, wherein the GRU model is applied to learn the patterns from the sequence of interaction data vector comprising of latent competency vector to generate the first set of jobs on the set of filtered jobs;
creating a second set of job recommendation by comparing the set of filtered jobs with one or more previously applied jobs by the user; and
estimating a third set of job recommendation by comparing the set of filtered jobs with the one or more jobs applied by the similar user profiles based on the presence of interaction data vector; and
presenting a combined set of job recommendation to the user on the communication interface pushed by the recommendation composer module based on a pre-determined threshold applied to the first, the second and the third set of job recommendations.

11. The method as claimed in claim 10, wherein the feature module is generated based on a plurality of parameters fetched from the one or more user profiles including but not limited to function match, domain match, educational requirements, location proximity between the users and the jobs, and matching of skills between the users and the jobs.

12. The method as claimed in claim 10, wherein the plurality of domain skills and the plurality of user skills are converted by a Word2vec model.

13. The method as claimed in claim 10, wherein the recommendation composer module lists jobs basis at least the one job filter wherein the job filter is determined by the feature module.

14. The method as claimed in claim 10, wherein the Gated Recurrent Unit model is modulated to analyze past sequential information of the one or more user profiles to predict the at least one set of job recommendations.

15. The method as claimed in claim 10, wherein the method includes performing a cosine similarity analysis on the set of filtered jobs and the one or more previously applied jobs by the user to generate the at least one set of second job recommendations.

16. The method as claimed in claim 10, wherein the method includes performing a cosine similarity analysis with the one or more user vectors to generate a score to identify the similar candidates to determine the at least one set of third job recommendations.

17. The method as claimed in claim 10, wherein the combined set of job recommendations is based on the pre-determined threshold value where recommendations are extracted from the first set of job recommendations, the second set of job recommendations and the third set of job recommendations, further wherein contribution by the analyses module and the evaluate module is less than or equal to 20 percent provided there are recommendation from the first set of jobs otherwise recommendations include jobs coming from the first set of the set of filtered jobs.
